(19) United States
(12) Patent Application Publication
(10) Pub. No.: US 2006/0131219 A1
(43) Pub. Date: Jun. 22, 2006

(54) Reverse osmosis filter machine with autocontrol structure

(75) Inventor: Kevin Chang, Taichung (TW)

Correspondence Address: TROXELL LAW OFFICE PLLC;SUITE 1404, 5205 LEESBURG PIKE, FALLS CHURCH, VA, 22041, US

(73) Assignee: Anderson R.O. Technology Co., Ltd.

(21) Appl. No.: 11/014,174

(22) Filed: Dec. 17, 2004

(51) Int. Cl. B01D 35/143

(52) U.S. Cl. 210/85; 210/138; 210/143; 210/321.65

(57) ABSTRACT

A reverse osmosis filter machine with autocontrol structure has an IC control system. The IC control system predetermines lifespan and maximum load of filter flux of filters, and computes respective operation time of said filters. A pure water sensor, a booster pump, a low pressure switch, a high pressure switch, an inlet electromagnetic valve and a washing electromagnetic valve connect together with the IC control system. The user knows operation state of the filters and the reverse osmosis filter at any time. The IC control system prompts replacement of the filters. The IC control system also determines whether water is allowed to flow into the filters, thereby automatically halting water when water quality is unqualified.

### BACKGROUND OF THE INVENTION

1. Field of the Invention

The present invention relates to a reverse osmosis filter machine with autocontrol structure, and particularly to a reverse osmosis filter machine with autocontrol structure which properly indicates operation states of filters, and which forces to halt water when the water quality up to the predetermined standard, thus users have to replace filters to assure water quality.

2. Related Art

Conventional reverse osmosis filter machines often need to replace filters by human. Different filters in a reverse osmosis filter machine have different replacement cycles. Correspondingly, people are so busy and often forget to replace filters actively and timely. It brings up some drawbacks as following.

Firstly, the filters are too dirty, and water quality is unqualified. When the filters fail to be replaced in time, the filters are always filled with much dirt, so cannot filter impurity. More seriously, the dirt may be carried with water, decreasing water quality and even doing harm to health.

Secondly, reverse osmosis membrane will be destroyed quickly. When the filters are too dirty and water quality is unqualified, impurity grains are carried to the reverse osmosis membrane. The reverse osmosis membrane can filter fine objects successfully rather than large impurity grains. The reverse osmosis membrane is often destroyed due to impact of large impurity grains. The destroyed reverse osmosis membrane cannot filter fine objects and need to be replaced, which increases cost.

Thirdly, in prior art, it is troublesome to determine which filter needs to be replaced, and to force to halt unqualified water. The filters have different duration because of different water quality and use frequency. Additionally, in prior art, people only can discern one outside filter whether it should be replaced since filters are opaque. The filters have different duration and are under different use conditions, it's also unsatisfactory that replacement of the filters depends on respective use time. Once the filters delay to replace, this filter machine cannot provide qualified water and even probably do harm to people. On the other hand, this filter machine cannot prevent unqualified water.

### SUMMARY OF THE INVENTION

Accordingly, an object of the present invention is to provide a reverse osmosis filter machine which has an Integrated Circuit (IC) control system to predetermine operation time of filters and a reverse osmosis filter, and which has a pure water sensor to detect water quality thereby prompting timely replacement of filters and halting water.

The reverse osmosis filter machine comprises an IC control system connecting with a power supply. The IC control system predetermines lifespan and maximum load of filter flux of filters, and computes respective operation time of the filters.

A pure water sensor, a booster pump, a low pressure switch, a high pressure switch, an inlet electromagnetic valve and a washing electromagnetic valve connect together with the IC control system. Thus the IC control system determines whether water is allowed to flow into the filters, thereby automatically halting water when water quality is unqualified.

### BRIEF DESCRIPTION OF THE DRAWINGS

FIG. 1 is a schematic structure view of a reverse osmosis filter machine with autocontrol structure according to the present invention.

FIG. 2 is a schematic circuit view of a reverse osmosis filter machine with autocontrol structure according to the present invention.

### DESCRIPTION OF THE PREFERRED EMBODIMENTS

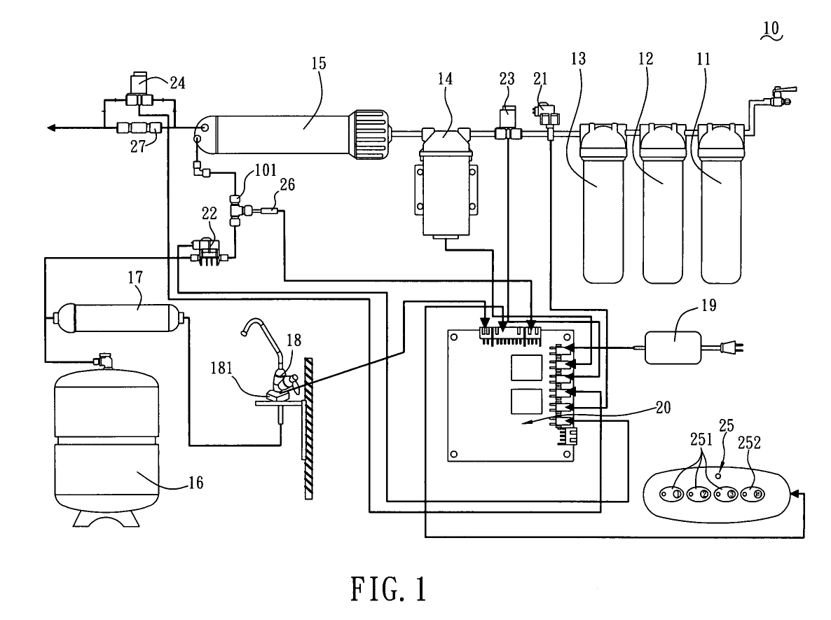

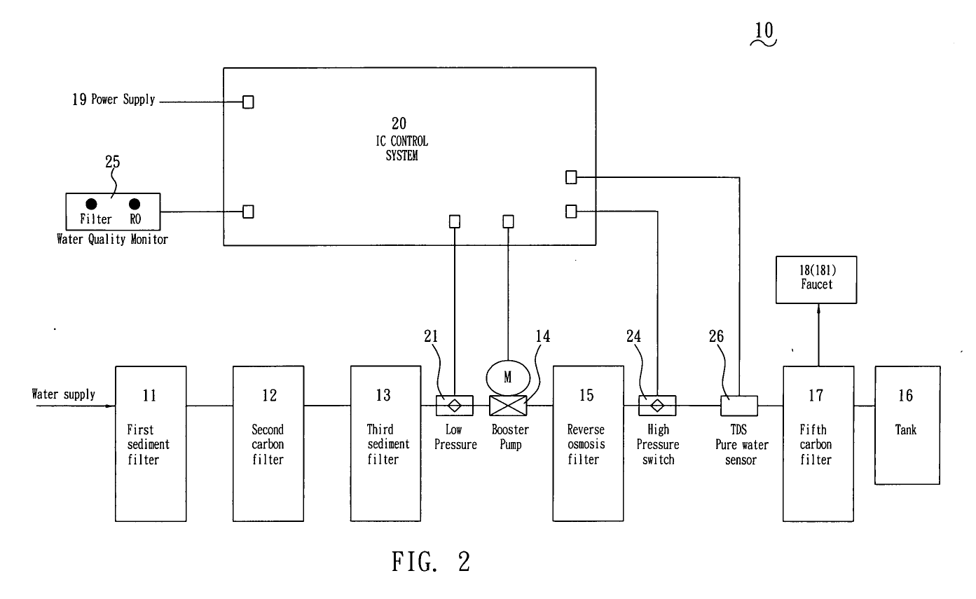

With reference to FIGS. 1 and 2, as a sample, a reverse osmosis filter machine 10 with autocontrol structure of the present invention has five filters 11, 12, 13, 15, 17 in series connected together. Each filter has an inlet and an outlet. A first sediment filter 11, a second carbon filter 12 and a third sediment filter 13 are connected in series to form a primary filter. The first sediment filter 11 connects with water supply. A booster pump 14 drives primarily filtered water, which has been filtered by the primary filter, into a reverse osmosis filter 15. Then reverse osmosis filtered water are reserved in a tank 16. When a faucet 18 connecting with the tank 16 is opened, water in tank 16 is pushed by inside pressure of the tank 16, and then flows through a fifth carbon filter 17 and outside the faucet 18. A low pressure switch 21 and an inlet electromagnetic valve 23 are provided between the third sediment filter 13 and the booster pump 14. The low pressure switch 21 is used to judge whether there is water supply. If there is no water supply, the low pressure switch 21 is retained closed, and the reverse osmosis filter 15 is not activated. A junction 101 is formed between the reverse osmosis filter 15 and the fifth carbon filter 17. A high pressure switch 22 is connected with the junction 101 for preventing the reverse osmosis filter 15 from working when the reverse osmosis filter 15 is full of water. A pure water sensor 26 is connected between the outlet of the reverse osmosis filter 15 and the high pressure switch 22 by the junction 101 for detecting total solid quantity of water from the reverse osmosis filter 15. A washing electromagnetic valve 24 and a waste water ratio restriction valve 27 are in multiple connected to the outlet of the reverse osmosis filter 15 and opposite to the junction 101. The washing electromagnetic valve 24 automatically washes after operation of the reverse osmosis filter 15, thereby preventing crystal and lengthening lifespan thereof. The low pressure switch 21, the high pressure switch 22, the inlet electromagnetic valve 23 and the washing electromagnetic valve 24 cooperate to provide sequential operations, including low pressure water supply, high pressure water interdiction, and automatic reverse osmosis filter, which are prior art and need not be recited in detail here. The reverse osmosis filter machine 10 of the present invention has an IC control system 20. The IC control system 20 electrically connects with a power supply 19, and connects and drives the low pressure switch 21, the high pressure switch 22, the inlet electromagnetic valve 23 and the washing electromagnetic valve 24. The pure water sensor 26 connects with the IC control system 20 to provide water rigidity information for the IC control system 20. A display panel 25 is connected with the IC control system 20 to show information of the IC control system 20. Setting keys 251, which respectively corresponds to each filter, are provided on the display panel 25. A water quality key 252, which corresponds to state of the reverse osmosis filter 15, is formed on the display panel 25. The IC control system 20 computes to display operation state of each filter on respective LED light on the display panel 25. When the first sediment filter 11, the second carbon filter 12 and the third sediment filter 13 are worn out or water quality are beyond threshold, the IC control system 20 drives the inlet electromagnetic valve to halt water supply and prompts to replace unqualified filter. The user may reset calculation program via the setting keys 251 and the water quality key 252. A faucet panel 181 is arranged near the faucet 18 for synchronously showing the information of the IC control system 20, including water quality information.

Tables. 1A and 1B show calculation programs and functions of the IC control system 20 controlling the first sediment filter 11, the second carbon filter 12 and the third sediment filter 13. Operation time of the first sediment filter 11, the second carbon filter 12 and the third sediment filter 13 are mainly based on lifespan and water flux. Preferably, the lifespan of the first sediment filter 11, the second carbon filter 12 and the third sediment filter 13 is on the basis of 90 days and increased in multiple of 90 days in sequence. As shown in Table 1, lifespan of the first sediment filter 11 is 90 days, lifespan of the second carbon filter 12 is 180 days, and lifespan of the third sediment filter 13 is 270 days. In consideration of different use frequency, water flux is a plus to control filters. For example, the IC control system 20 calculates most water flux value by operation time of each filter dividing water flux. As a sample, water supply is 500 cc/minute, the IC control system 20 calculates total operation time of each filter under most water flux. As for each filter, either of lifespan or most water flux value reaches a threshold, the setting keys 251 display according to Tables 1A and 1B, and the reverse osmosis filter machine 10 operates according to Table 1A. If the user doesn't replace the specified filter shown in display panel 25, the IC control system 20 forces to stop the booster pump 24 and to close the inlet electromagnetic valve 23, and therefore forces the user to replace filters according to LED light instruction.

Table 2 shows controlling programs and functions of the IC control system to the reverse osmosis filter 15. After water are processed by the reverse osmosis filter 15, the pure water sensor 26 detects total dissolved solids (TDS), thereby avoiding mistaken replacement of expensive reverse osmosis filter 15 and simultaneously assuring water quality. TDS value is determined complying for safety regulations. If the pure water sensor 26 finds that water from the reverse osmosis filter 15 is unqualified, the water quality key 252 is set to display. At the same time, the IC control system 20 forces to stop the booster pump 24 and to close the inlet electromagnetic valve 23, and forces the user to replace the reverse osmosis filter 15. After filter replacement, the user may reset the reverse osmosis filter machine 10 via keys on the display panel 25.

TABLE 1A

| | Light | | | | | Lifespan | | | | |
|---|---|---|---|---|---|---|---|---|---|---|
| | Display | | | | | First | Second | Third | | |
| | panel | | | Faucet | | sediment | carbon | sediment | Pump | |
| | Red LED | | | panel | | filter | filter | filter | control | |
| Mode | 1 | 2 | 3 | Blue | Red | 3 months | 6 months | 9 months | open | close |
| Normal | | | | ● | | | | | V | |
| mode | | | | | | | | | | |
| Warning | ★ | | | ★ | ★ | V | | | V | |
| mode | ★ | ★ | | ★ | ★ | V | V | | V | |
| | ★ | ★ | ★ | ★ | ★ | V | V | V | V | |
| Obliged | ● | | | | ● | V | | | | V |
| replacement | | | | | | | | | | |

TABLE 1B

| | | | | | | | Warning period | | |
|---|---|---|---|---|---|---|---|---|---|
| | The first | | The second | | The third | | (time) | | |
| Mode | T1 time | F1 flux | T2 time | F2 flux | T3 time | F3 flux | T time | F flux | setting |
| normal - 1 | 90 days | 10260 | 180 | 20520 | 270 | 30780 | 7 days | 840 | Under |
| | | minutes | days | minutes | days | minutes | Before | minutes | CN7(2, 3), |
| | | | | | | | | Before | short-cut |
| normal - 2 | 60 days | 6840 | 120 | 13680 | 180 | 20520 | 7 days | 840 | Under |
| | | minutes | days | minutes | days | minutes | Before | minutes | CN7(1, 2), |
| | | | | | | | | Before | short-cut |
| test - 1 | 1 minute | | 2 | | 3 | | 30 | | boost + S1(3 |
| | | | minutes | | minutes | | seconds | | second) |
| | | | | | | | Before | | |
| test - 2 | 20 minutes | | 40 | | 60 | | 2 | | boost + S2(3 |
| | | | minutes | | minutes | | minutes | | second) |
| | | | | | | | Before | | |
| test - 3 | | 10 | | 20 | | 30 | | 2 | boost + S3(3 |
| | | minutes | | minutes | | minutes | | minutes | second) |
| | | | | | | | | before | |

★: standing for LED lights flickering
●: standing for LED lights always lighting
V: standing for operating the action
F: flux is 500 cc/minute.

TABLE 2

| | Light | | | | | | | |
|---|---|---|---|---|---|---|---|---|
| | Display | | | TDS | | | | |
| | panel | | | | | Stop | | |
| | reverse | Faucet | | Normal | Warning | mode | Pump | |
| | osmosis | panel | | mode | mode | Over | control | |
| Mode | (red) | blue | red | 5 ppm | 25 ppm˜40 ppm | 40 pmm | open | close |
| Normal mode | | ● | | V | | | V | |
| Warning mode | ★ | ★ | ★ | | V | | V | |
| Stop mode | ● | | ● | | | V | | V |
| Reverse osmosis | ▴ | ▴ | ▴ | | | | V | |
| filter membrane | | | | | | | | |
| replacement | | | | | | | | |

★: standing for LED light flickering ∘
●: standing for LED light always lighting ∘
V: standing for operating the action ∘

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A reverse osmosis filter machine with autocontrol structure, which connects with water supply, comprising:
a plurality of filters connected together in series, each filter having an inlet and an outlet, an inlet of a filter at an end among the filters connecting with water supply, an outlet of another filter at an opposite end among the filters connecting with a faucet;
a reverse osmosis filter also having an inlet and an outlet, and in series connecting with said filters;
a booster pump provided between the inlet of the reverse osmosis filter and said filters;
a low pressure switch provided between the booster pump and said filters, and connecting in series with an inlet electromagnetic valve;
a high pressure switch provided between the outlet of the reverse osmosis filter and said filters;
a tank connecting with the outlet of the reverse osmosis filter; and
an IC control system connecting with a power supply for providing power, and predetermining lifespan and maximum load of filter flux of said filters and the reverse osmosis filter, the IC control system further connecting with the booster pump, the low pressure switch and the high pressure switch, thereby computing respective operation time of the reverse osmosis filter and said filters to provide replacement time thereof and function as halt water to assure water quality.

2. The reverse osmosis filter machine with autocontrol structure as claimed in claim 1, wherein lifespan of each of said filters is on the basis of 90 days and increased in multiple of 90 days in sequence.

3. The reverse osmosis filter machine with autocontrol structure as claimed in claim 2, wherein the filters includes a first filter, a second filter and a third filter, and wherein lifespan of the first filter is 90 days, lifespan of the second filter is 180 days, and lifespan of the third filter is 270 days.

4. The reverse osmosis filter machine with autocontrol structure as claimed in claim 2, wherein the IC control system calculates maximum load of water flux by dividing operation time by water flux 500 cc per minute, thereby supervising water flux.

5. The reverse osmosis filter machine with autocontrol structure as claimed in claim 1, wherein a pure water sensor is connected between the outlet of the reverse osmosis filter and the high pressure switch by a junction for detecting total solid quantity of water from the reverse osmosis filter.

6. The reverse osmosis filter machine with autocontrol structure as claimed in claim 1, wherein a washing electromagnetic valve is connected to the outlet of the reverse osmosis filter for automatically washing after operation of the reverse osmosis filter.

7. The reverse osmosis filter machine with autocontrol structure as claimed in claim 6, wherein a waste water ratio restriction valve is in multiple connected to the washing electromagnetic valve.

8. The reverse osmosis filter machine with autocontrol structure as claimed in claim 1, wherein a display panel is connected with the IC control system for showing information of the IC control system.

9. The reverse osmosis filter machine with autocontrol structure as claimed in claim 1, wherein a faucet panel is arranged near the faucet for synchronously showing water quality information.

10. The reverse osmosis filter machine with autocontrol structure as claimed in claim 1, wherein said filters include carbon filters and sediment filters which are arranged in sequence.
